(19) United States
(12) Patent Application Publication
(10) Pub. No.: US 2018/0227803 A1
(43) Pub. Date: Aug. 9, 2018

(54) QUALITY OF SERVICE CONTROL

(71) Applicant: NOKIA SOLUTIONS AND NETWORKS OY, Espoo (FI)

(72) Inventors: Mehdi BENNIS, Oulu (FI); Kari Veikko HORNEMAN, Oulu (FI)

(21) Appl. No.: 15/506,080

(22) PCT Filed: Aug. 28, 2014
(86) PCT No.: PCT/EP2014/068250

§ 371 Date: Feb. 23, 2017

(51) Int. Cl. H04W 28/24; H04W 8/22; H04W 24/08

(52) U.S. Cl. CPC H04W 28/24; H04W 24/08; H04W 8/22

(57) ABSTRACT

There is provided a method for controlling quality of service in a network, the method may include: obtaining network traffic prediction information and coverage information of the network, predicting a service availability for at least one terminal device based at least on the network traffic prediction information and the coverage information, and controlling the quality of service for the at least one terminal device based on the service availability.

### FIELD

The invention relates generally to cellular networks, and more particularly, to quality of service in cellular networks.

### BACKGROUND

The demand for more efficient networks has risen in the recent years as applications and services have become more and more data demanding. At the same time the complexity of networks has also increased. Therefore, controlling the network's ability to manage the increased data demand and complexity has become a popular topic, and finding solutions for better control might be beneficial for the network's capability.

### BRIEF DESCRIPTION

Aspects of the invention are defined by the independent claims.

Some further embodiments are defined in the dependent claims.

### BRIEF DESCRIPTION OF THE DRAWINGS

In the following embodiments will be described in greater detail with reference to the attached drawings, in which

FIG. 1 shows an example communication network to which embodiments of the invention may be used;

FIG. 2 illustrates a flow diagram according to an embodiment of the invention;

FIG. 3 illustrates mobility information acquiring according to an embodiment of the invention;

FIG. 4 illustrates coverage information acquiring according to an embodiment of the invention;

FIG. 5 illustrates an embodiment of the invention;

FIG. 6 illustrates a flow diagram according to an embodiment of the invention;

FIGS. 7 to 8 illustrate apparatuses according to some embodiments of the invention; and

FIG. 9 illustrates an embodiment of the invention.

### DETAILED DESCRIPTION

The following embodiments are exemplary. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

Embodiments described may be implemented in a radio system, such as in at least one of the following: Worldwide Interoperability for Micro-wave Access (WiMAX), Global System for Mobile communications (GSM, 2G), GSM EDGE radio access Network (GERAN), General Packet Radio Service (GRPS), Universal Mobile Telecommunication System (UMTS, 3G) based on basic wideband-code division multiple access (W-CDMA), high-speed packet access (HSPA), Long Term Evolution (LTE), LTE-Advanced, and/or 5G system. The present embodiments are not, however, limited to these protocols.

FIG. 1 shows an example of a communication network to which embodiments of the invention may be used. Radio communication networks, such as the Long Term Evolution (LTE) or the LTE-Advanced (LTE-A) of the 3rd Generation Partnership Project (3GPP), are typically composed of at least one network node 102 providing a cell 104. Each cell may be, e.g., a macro cell, a micro cell, or a pico-cell, for example. The base station may be an evolved node B (eNB) as in the LTE and LTE-A, a radio network controller (RNC) as in the UMTS, a base station controller (BSC) as in the GSM/GERAN, or any other apparatus capable of controlling radio communication and managing radio resources within a cell. The network node 102 may be a base station or a small base station, for example. In the case of multiple eNBs in the communication network, the eNBs may be connected to each other with an X2 interface as specified in the LTE. Other communication methods between the network nodes may be possible. The network node 102 may be further connected via an S1 interface to an evolved packet core (EPC) 130, more specifically to a mobility management entity (MME) and to a system architecture evolution gateway (SAE-GW). The network node 102 may control a cellular radio communication link 112 established between the network node 102 and at least one terminal device 110 located within or comprised in the cell 104. The communication link 112 may be referred to as conventional communication link for end-to-end communication, where the source device transmits data to the destination device via the network node 102 and/or core network. The at least one terminal device 110 may be a terminal device of a cellular communication system, e.g. a computer (PC), a laptop, a palm computer, a mobile phone, a tablet, a phablet or any other user terminal or user equipment capable of communicating with the cellular communication network.

Still referring to FIG. 1, the quality of the communication link 112 may vary within the cell 104. Thus, a service availability for the at least one terminal device 110 may also vary. There may be several reasons for the communication link 112 to vary. One reason may be shadow areas, such as shadow area 106. Shadow area 106 may be caused by a road tunnel, a building, a natural obstacle or an interference source, to mention a few. Within the shadow area 106 communication link 112 may not be possible as the communication link 112 is interfered or blocked. This may mean that the service availability for the at least one terminal device 110 decreases or the service may not at all be possible. The at least one terminal device 110 may travel through the shadow area 106, as shown with a dotted arrow in FIG. 1. It may also be possible for the at least one terminal device 110 to be stationary within the shadow area 106. The shadow area 106 may be covered by another network node providing service to the at least one terminal device 110, but this might not always be the case. It may be beneficial to control the service availability for the at least one terminal device 110.

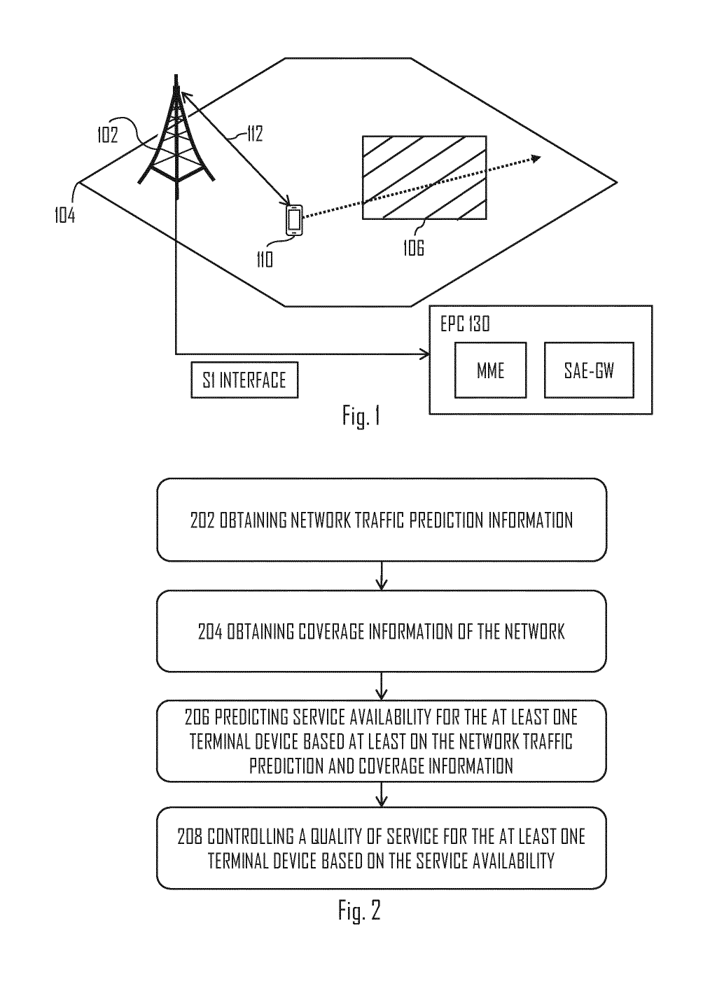

FIG. 2 illustrates a flow diagram of an embodiment of the invention. The other accompanying Figures may provide further embodiments by describing the method of FIG. 2 in details. In step 202, a first network node comprised in a network, such as the network node 102 of FIG. 1, may obtain network traffic prediction information. In step 204, the first network node may obtain coverage information of the network. The coverage information may comprise coverage map of the first network node and/or coverage maps of other network nodes. The network node may update coverage information based on coverage measurements, for example. In step 206, the first network node may predict a service availability for the at least one terminal device 110 based at least on the network traffic prediction information and the coverage information. The service availability may describe the first network node's ability to provide the requested service for the at least one terminal device 110. For example, if the at least one terminal device 110 requests video transmission from the first network node, the service availability may indicate that with the current terminal trajectory the video transmission may not be possible after certain timeframe or the transmission is too low to provide decent quality. The service availability may further be based on the service that is being used in the at least one terminal device 110. For example, music playback may require smaller data rate than video playback. In step 208, based on the service availability, the first network node may control a quality of service for the at least one terminal device 110.

In an embodiment, the network traffic prediction information comprises information of available network resources. The available network resources may mean the transmission resources which are available in the network for data transmission at the moment or in the future. The amount of available resource may be the total amount of network resources minus the resources reserved. The reserved resources may already be in use, reserved to be used or prioritized for a certain function, such as data transmission for a certain device in a given time.

In an embodiment, the network traffic prediction information comprises estimation of future service request in the network. The estimation may be based on historical data. The said historical data may comprise current location, RSSI and previous service requests of the at least one terminal device 110. Moreover, the said historical data may comprise frequently updated coverage maps. In an embodiment, the first network node or a local controller, controlling a group of network nodes in a network, may perform the estimation of future service requests based on the historical data.

Additionally, the prediction may be based on predicting future applications of the at least one terminal device 110. The data rates corresponding to the applications may be know from historical data. It may also be possible to gain more information about the future applications by creating a social profile of the user. This may include information about home and work location, preferred routes and preferred applications of the user. For example, the preferred routes may comprise routes which the user uses when going to work or going back to home from the work. As there may be other route options available, the routes the user most often uses may be considered to be preferred routes for the user. In an embodiment, preferred routes may comprise routes which are used regularly, for example, more than once a week. The preferred applications may comprise applications user uses regularly. For example, this may mean applications which require the most data transmission from a pool of applications used by the user. In an embodiment, the preferred applications comprise applications which are used regularly, for example more than once a day or a week. It might be possible to list preferred applications for a certain preferred route. For example, when the user goes to work the user may use certain application regularly. Thus, the social profile may comprise information about application preferences corresponding to a certain preferred route, for example.

In an embodiment, the at least one terminal device 110 may acquire information about the future service requests of the at least one terminal device 110. For example, the device may know a synching routine of an email application. Thus, it may be possible to use this knowledge to acquire information about future service requests. The first network node may obtain said information about future service requests of the at least one terminal device 110, wherein the service availability prediction is further based on the said obtained future service requests information. The at least one terminal device 110 may, for example, transmit the information about future service requests to the first network node. In an embodiment, the first network node sends a request to the at least one terminal device, wherein the request causes the at least one terminal device 110 to send the information about the future service requests.

In an embodiment, the network traffic prediction information comprises device characteristic of the at least one terminal device 110. The first network node may obtain the device characteristics of the at least one terminal device 110, wherein the service availability prediction is further based on the device characteristics. The device characteristics may comprise screen size, operating system, screen resolution, memory size, processing circuitry information and communication circuitry information, to name a few. The device characteristics may be used to build a classification of the at least one terminal device 110. The said classification may define how fast the at least one terminal device 110 may adopt new data. For example, the adopting of data may be restricted by the communication circuitry's ability to receive data. In another example, a large memory may enable pre-buffering of a large amount data to the device. The said classification may comprise device's ability to receive data, ability to process data and ability to store data, for example. The adopting of data may comprise all or some of the said abilities, thus classifying the at least one terminal device 110.

The device characteristics may provide information about the data requests of the at least one terminal device 110. For example, screen size may help to define how much data is needed for a high definition video stream for a certain device. The device characteristics may be transmitted, by the terminal device 110, to the first network node.

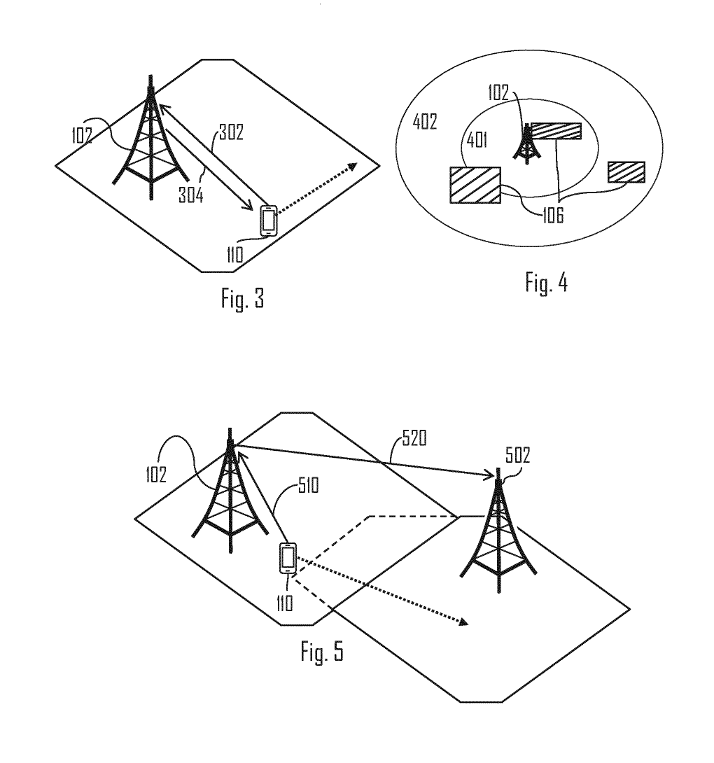

FIG. 3 illustrates mobility information acquiring according to an embodiment of the invention. The network traffic prediction information described above may comprise the mobility information. Referring to FIG. 3, the at least one terminal device 110 may obtain information of its speed, direction and current location. This information may be used to estimate the at least one terminal device's 110 trajectory in relation to its current location. The at least one terminal device 110 may use, for example, GPS, compass, acceleration sensor, gyroscope, motion sensors, or Bluetooth to determine its trajectory and location.

In an embodiment, the trajectory and location of the at least one terminal device 110 is measured by the network node 102. Using the trajectory information and current location, it may be possible to deduce the areas which the at least one terminal device 110 may travel through. It may be possible for the at least one terminal device 110 to use historical data and user preferences to estimate with better accuracy the trajectory of the device. For example, if a user drives to work each day, the at least one terminal device may use this history data to estimate the trajectory of the device, based at least partly on the historical data. If the historical data seems to correspond with the current trajectory and location measurements, the trajectory information may be more accurate.

The at least one terminal device 110 may transmit 302 mobility information comprising trajectory and location information to the network node 102. In an embodiment, the at least one terminal device 110 deduces only information of its assumed location over time. This said information may be transmitted 302 to the network node 102.

Still referring to FIG. 3, the network node 102 may request 304 the at least one terminal device 110 to start obtaining the trajectory and location information. The network node 102 may also provide the at least one terminal device 110 the trajectory and location information, if the measuring is done at least partly by the network node 102 or by a group of network nodes. For example, the group of network nodes may perform triangulation to the at least one terminal device 110 to determine its location.

In an embodiment, the mobility information may be referred to as enhanced mobility state estimation (MSE), wherein the enhanced MSE comprises the trajectory information of the at least one terminal device 110 and normal MSE, described in the LTE specification. The trajectory information may comprise information about the velocity towards or away from the network node 102 or tangential. Said information may be based on some predefined thresholds, which define when the velocity is considered to be towards, away or tangential in relation to the network node 102. For example, the tangential velocity may refer to a situation where the at least one terminal device 110 is moving to a direction which is not directly away or towards the network node 102. This may mean that the at least one terminal device 110 is moving away or towards the network node 102 with an angle.

In an embodiment, the mobility information comprises the device characteristics. The device characteristics may be also transmitted in conjunction with the mobility information.

FIG. 4 illustrates the coverage information acquiring according to an embodiment of the invention. Referring to FIG. 4, a network node, such as the network node 102, may obtain coverage maps of the network that may comprise the network node 102. The coverage map may comprise information about the shadow areas 106. The coverage map may further comprise information about different coverage areas 401, 402. The service availability may vary between the coverage areas 401, 402, although the service availability would be at an acceptable level at both areas. Communication link, such as communication link 112 of FIG. 1, may be faster and/or more stable when the at least one terminal device 110 is within the first coverage area 401 compared to the second coverage area 402. This may mean that the network node 102 may require less transmission time to provide same service to the at least one terminal device 110. Shorter transmission time may help the network node 102 to save energy and allocate resources to other devices, for example. In an embodiment, the said communication link may be better when the at least one terminal device 110 is within the second coverage area 402. The coverage maps may comprise the coverage map of the current network node 102 and coverage maps of other network nodes, for example, coverage maps of network nodes in the same network. This may be further facilitated and coordinated via a local controller.

In an embodiment, the trajectory and/or mobility information determination is triggered if certain conditions are met. These conditions may comprise at least one of the following: a delay-tolerant application is running in the at least one terminal device 110, devices velocity is above a predefined threshold and the device is under coverage of a heterogeneous network (HetNet). In an embodiment, all the mentioned conditions are required to be true for the triggering to happen. The triggering may further require a certain measured key performance indicator (KPI) to be under a defined threshold value for or over certain time duration. For example, measured wideband signal-to-interference-plus-noise ratio (SINR) may be under a defined threshold for ten seconds. This may cause the triggering to happen, if above-mentioned condition(s) are met. The HetNet may comprise eNBs and/or WiFi access points, for example, or eNBs and small cell base stations, such as home eNBs. The determination that the device is under coverage of HetNet may be based on location of the at least one terminal device 110 and coverage information and/or coverage maps. The said triggering may be initiated by the network node 102, for example. The triggering may also happen in the at least one terminal device 110. The at least one terminal device 110 may acquire information that it is in the HetNet. This may be achieved, for example, by the network node 102 informing the at least one terminal device 110 with system information that the at least one terminal device 110 is in coverage of the HetNet, or by the at least one terminal device 110 receiving signals from two different types of network nodes, base stations or networks.

In an embodiment, the mobility information determination is stopped when the conditions for triggering are determined to cease to exist. For example, the network node 102 may determine that the at least one terminal device 110 has stopped using a delay-tolerant application, velocity is under a predetermined level and/or the device is no longer under coverage from HetNet, and as a response to the determination send a message to the at least one terminal device 110, wherein the message causes the at least one terminal device 110 to stop sending the mobility information. Similarly, the at least one terminal device 110 may determine itself that the conditions for sending mobility information no longer exists, and stop transmitting the mobility information.

In an embodiment, the coverage maps include pre-calculated information about how long it will take for the at least one terminal device 110 to pass over a certain coverage area 401, 402, shadow areas 106 and the cell itself with a certain device velocity. The coverage map may comprise information of multiple cells, provided by the network node 102, by a second network node or by a WiFi access point.

In an embodiment, the second network node may keep updating coverage maps(s) comprising trajectory information of the at least one terminal device 110 received from the network node 102. The second network node may use those said map(s) to predict the coming traffic and prepare scheduling based on service needs. The cooperation between network nodes may include also handover predictions and buffering the content of an application for coming handovers. It may be possible for the network nodes to provide at least one terminal device 110 the same service at the same time. This may mean that, for example, different video segments or frames are transmitted to the at least one terminal device 110 from different sources simultaneously or consecutively. Ultimately, if the at least one terminal device's 110 trajectory crosses areas of two network nodes, the network nodes may plan the handover as efficiently as possible using the above mentioned means.

In an embodiment, the service availability is defined as a function of the at least one terminal device's 110 velocity with a velocity trajectory and a cell, provided by the network node 102, size. The service availability may comprise only the maximum service availability with limited number of velocities trajectory crossing the cell and correction weightings for other velocities and trajectories.

In an embodiment, the first network node is or comprises the network node 102. The first network node may be a base station or a small base station, for example.

In an embodiment, the controlling of the quality of service comprises predictively storing, by the network node 102, data in the at least one terminal device 110. For example, if the at least one terminal device 110 is using a video or music service, the network node 102 may determine, based on the service availability, that for the playback to run smoothly the service may have to be preloaded into the at least one terminal device 110. Such situation may happen, for example, if a service is being used on a device which is determined to be travelling through or into a shadow area, such as the shadow area 106 of FIG. 1. It may be possible for the network node 102 to predictively store data when the channel conditions are good. For example, the network node 102 may schedule the at least one terminal device 110 transmission to a time when the transmission would be the most efficient. In an embodiment, it may also or instead be possible for the network node 102 to preload the data to a second network node. A second network node may be configured to transmit the preloaded data to the at least one terminal device 110. It may be possible to configure a local controller to further coordinate the storing of data predictively. The local controller may allow network nodes to exchange information about their current load levels. Scheduling decisions, by the network nodes, may at least partially be based on the said exchanged information in addition to received signal strength indicator (RSSI) from the at least one terminal device 110.

In an embodiment, the controlling of the quality of service comprises changing, by the network node 102, the priority of the data transmission to the at least one terminal device 110. Based on the service availability, the network node 102 may determine that a higher priority is needed for the data transmission. This may mean allocating more physical resource blocks (PRBs) to the at least one terminal device 110. Similarly, a lower priority may be determined to be beneficial, if the service does not require so many PRBs, or if the device is determined to be travelling to an area where higher data rate is possible.

In an embodiment, the controlling of the quality of service comprises routing, by the network node 102, the data to the at least one terminal device 110 using a second network node. The routing may be done via X2-interface, for example. The second network node may be configured to transmit the routed data to the at least one terminal device 110. In an embodiment, the second network node is a base station. The second network node may be a WiFi access point or similar network node. The second network node may be a small cell base station configured to increase network's capability in areas where increased network capability is required. These areas may be for example, more densely populated. In a case of routing the data through the WiFi evolved packet system (EPS) bearers may be used.

In an embodiment, the controlling of the quality of service comprises delaying, by the network node 102, the data transmission to the at least one terminal device 110. This may be beneficial, if the at least one terminal device 110 is determined to be in or to travel through a shadow area, or if the at least one terminal device 110 is travelling to an area where higher data rate may be possible.

In an embodiment, the enhanced MSE is used as input information for a packet scheduler both for downlink and uplink. The network node 102 may comprise the packet scheduler. The enhanced MSE may be used to control the size of the data buffer, as described above, reserved for an application with a certain quality of service (QoS) class. Channel quality indicator (CQI) may be used to determine whether the scheduler should increase or decrease the data buffer. The uplink direction management of the buffer may be done by the at least one terminal device 110. Thus, there may be a need to provide additional data buffer status reports to the network node 102 from the at least one terminal device 110. The sending of the data buffer status report may be triggered in the at least one terminal device 110 based on the enhanced MSE, or it may triggered in the packet scheduler in the network node 102 by a report request. Similarly, the packet scheduler may control the above mentioned priority changing, routing and delaying of the data transmission.

In an embodiment, the mobility information comprises location and trajectory information of the at least one terminal device 110, as shown in FIG. 3. The mobility information may further comprise more dynamic data such as social networking data or other geo-tagged location based service and/or application data. One example of this location based data may be navigation application which may be capable of determining used work route or some other route used by the user of the at least one terminal device 110.

In an embodiment, the network node 102 performs triggering, wherein the triggering causes the at least one terminal device 110 to start transmitting the mobility information and/or some other information, such as device characteristics, for example. The triggering may comprise sending a request to the at least terminal device 110, by the network node 102, wherein the request causes the at least one terminal device 110 to start transmitting the mobility information. In an embodiment, the at least one terminal device 110 determines itself that mobility information is beneficial to be transmitted. Thus, the triggering may be done by the at least one terminal device 110 itself. The triggering, by the at least one terminal device 110, may take place when at least one of the following requirements is met: a delay-tolerant application is running in the at least one terminal device 110, at least one terminal device's 110 velocity is above a predefined threshold and the device is under coverage of HetNet, as described above. The predefined threshold may be a velocity limit, such as 5 km/h, 10 km/h or 50 km/h, for example.

FIG. 5 illustrates an embodiment of the invention. Referring to FIG. 5, the controlling of the quality of service may comprise sending a request 520, by the network node 102, to a third network node 502, wherein the request may cause the third network node 502 to perform at least one of the following: predictively storing data in the at least one terminal device 110, changing the priority of the data transmission to the at least one terminal device 110, routing the data to the at least one terminal device 110 using a fourth base station or a fourth network node and delaying the data transmission to the at least one terminal device 110. The request 520 may be sent via X2-interface, for example. In an embodiment, the network node 102 sends the request 520 to the third network node 502 using the at least one terminal device 110 as a carrier. This may mean that the request 520 is sent to the at least one terminal device 110, wherein the request 520 causes the at least one terminal device 110 to transmit the request 520 to the third network node 502. The above mentioned method may be beneficial, for example, when the at least one terminal device 110 is travelling through an area where data transmission from the third network node 502 is more efficient compared to a data transmission from the network node 102.

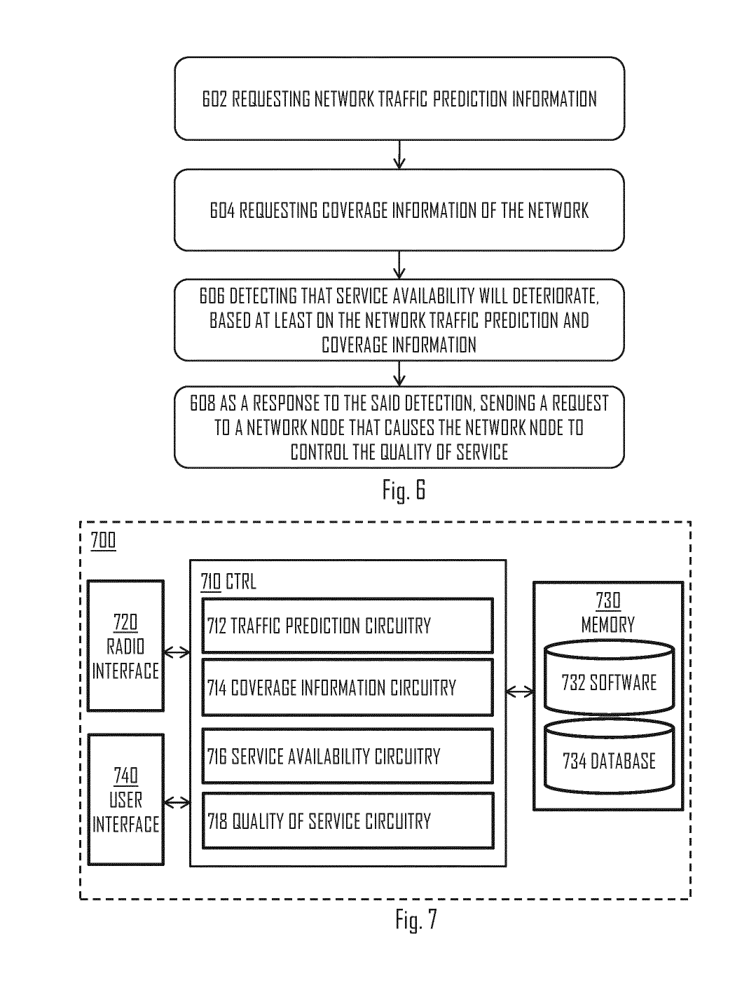

FIG. 6 illustrates a flow diagram of an embodiment of the invention. Referring to FIG. 6, in step 602 the at least one terminal device 110 may request the network traffic prediction information from the network node 102. The network node 102 may, as a response to the request, transmit the traffic prediction information to the at least one terminal device 110. The at least one terminal device 110 may receive the traffic prediction information. Similarly, in step 604 the at least one terminal device 110 may request and receive the coverage information of the network. In step 606, the at least one terminal device 110 may detect, based on the network prediction information and the coverage information, that a service availability will deteriorate. In step 608, the at least one terminal device 110 may send a request, as a response to the said detection, to the network node 102, wherein the request causes the network node 102 to perform at least one of the following functions to control the quality of service for the at least one terminal device 110: predictively storing data in the at least one terminal device 110, changing the priority of the data transmission to the at least one terminal device 110, routing the data to the at least one terminal device 110 via a second network node and delaying the data transmission to the at least one terminal device 110.

In an embodiment, the at least one terminal device 110 sends a request 510 to the network node 102, wherein the request causes the network node 102 to perform at least one of the following: predictively storing data in the at least one terminal device 110, changing the priority of the data transmission to the at least one terminal device 110, routing the data to the at least one terminal device 110 using the third network node 502 and delaying the data transmission to the at least one terminal device 110.

In an embodiment, the at least one terminal device 110 requests from the network node 102 the coverage information. The coverage information may comprise the coverage map(s). After receiving the coverage maps from the network node 102, the terminal device 110 may detect, based on the coverage information and the determined mobility information that a problem with respect to the service availability will occur. Thereafter, as a response to the said detection, the terminal device 110 requests the network node 102 to perform at least one of the following: predictively storing data in the at least one terminal device 110, changing the priority of the data transmission to the at least one terminal device 110, routing the data to the at least one terminal device 110 using the third base station and delaying the data transmission to the at least one terminal device 110.

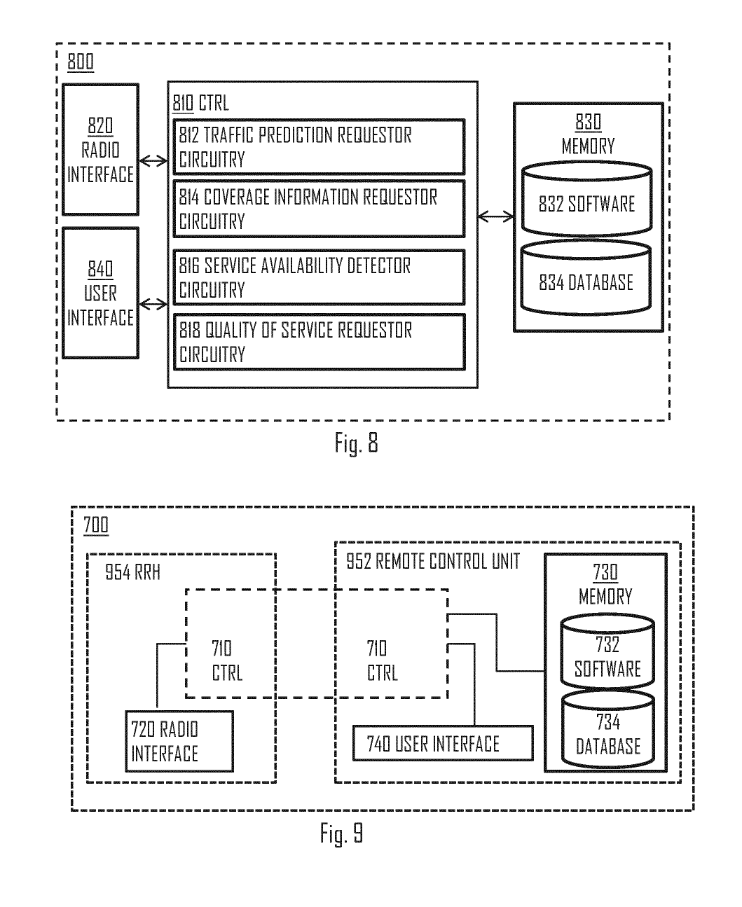

FIGS. 7 to 8 provide apparatuses 700, 800 comprising a control circuitry (CTRL) 710, 810, such as at least one processor, and at least one memory 730, 830 including a computer program code (software) 732, 832, wherein the at least one memory and the computer program code (software) 732, 832, are configured, with the at least one processor, to cause the respective apparatus 700, 800 to carry out any one of the embodiments of FIGS. 1 to 6, or operations thereof.

In an embodiment, these operations may comprise tasks, such as, obtaining, by a network node, network traffic prediction information, obtaining coverage information of the network, predicting a service availability for at least one terminal device based at least on the network traffic prediction information and the coverage information, and controlling, based on the service availability, a quality of service for the at least one terminal device.

In an embodiment, these operations may comprise tasks, such as, requesting, by at least one terminal device, network traffic prediction information, requesting coverage information of the network, detecting, based on the network prediction information and the coverage information, that a service availability will deteriorate, and as a response to the said detection, sending a request to a network node, wherein the request causes the network node to perform at least one of the following: predictively storing data in the at least one terminal device, changing the priority of the data transmission to the at least one terminal device, routing the data to the at least one terminal device via a second network node, and delaying the data transmission to the at least one terminal device.

Referring to FIG. 7, the memory 730 may be implemented using any suitable data storage technology, such as semiconductor based memory devices, flash memory, magnetic memory devices and systems, optical memory devices and systems, fixed memory and removable memory. The memory 730 may comprise a database 734 for storing data, such as coverage information and/or coverage maps, as described above.

The apparatus 700 may further comprise radio interface (TRX) 720 comprising hardware and/or software for realizing communication connectivity according to one or more communication protocols. The TRX may provide the apparatus with communication capabilities to access the radio access network and enable communication between network nodes, for example. The TRX may comprise the above-mentioned X2-interface. The TRX may comprise standard well-known components such as an amplifier, filter, frequency-converter, (de)modulator, and encoder/decoder circuitries and one or more antennas.

The apparatus 700 may also comprise user interface 740 comprising, for example, at least one keypad, a microphone, a touch display, a display, a speaker, etc. Each user interface may be used to control the respective apparatus by the user.

In an embodiment, the apparatus 700 may be or be comprised in a base station (also called a base transceiver station, a Node B, a radio network controller, or an evolved Node B, for example). In an embodiment, the apparatus 700 is or is comprised in the etwork node 102.

The control circuitry 710 may comprise a traffic prediction circuitry 712, wherein the traffic prediction circuitry 712 may be configured to obtain the network traffic prediction information. The traffic prediction circuitry may be capable of receiving the said information and/or capable of predicting itself the said information. The control circuitry 710 may comprise coverage information circuitry 714 configured to obtain the coverage information of the network. The coverage information circuitry may be capable of receiving, updating and/or creating coverage maps of networks. The coverage information and/or traffic prediction information may be stored in and loaded from the database 734. The traffic prediction circuitry 712 may receive a request to send the network traffic prediction information to the requestor. The traffic prediction circuitry 712 may send the requested information to the requestor, for example to the at least one terminal device 110. Similarly, it is possible for the coverage information circuitry 714 to receive requests and send the coverage information to another device or network node.

The control circuitry 710 may further comprise service availability circuitry 716, wherein the service availability circuitry 716 may be configured to predict the service availability the at least one terminal device 110, based on the above-mentioned coverage information and the network traffic prediction information. Based on the service availability predicted by the service availability circuitry 716, the quality of service circuitry 718 may control the quality of service of the at least one terminal device 110. In an embodiment, the service availability circuitry 716 determines and/or receives the service availability information of the at least one terminal device 110. In an embodiment, the apparatus 700 receives a request to control quality of service of the at least one terminal device 110. The quality of service circuitry 718 may perform at least one of the following: predictively store data in the at least one terminal device 110, change the priority of the data transmission to the at least one terminal device 110, route the data to the at least one terminal device 110 via a second network node and delay the data transmission to the at least one terminal device 110.

Additionally, the control circuitry 710 may be configured to perform triggering, wherein the triggering causes the at least one terminal device 110 to star sending the mobility information. The control circuitry 710 may determine that conditions for the triggering are met and send a request, using the communication interface 720, to the at least one terminal device 110 to start sending the mobility information. The control circuitry 710 may determine, after the request has been sent, that the at least one terminal device 110 is sending the mobility information, and based on the determination send a new request if the mobility information transmission has not started after a certain timeframe. Similarly, the control circuitry 710 may send a request to stop the mobility information transmission, as described above.

Referring to FIG. 8, the memory 830 may be implemented using any suitable data storage technology, such as semiconductor based memory devices, flash memory, magnetic memory devices and systems, optical memory devices and systems, fixed memory and removable memory. The memory 830 may comprise a database 834 for storing data, such as coverage information, coverage maps and/or mobility information, as described above.

The apparatus 800 may further comprise radio interface (TRX) 820 comprising hardware and/or software for realizing communication connectivity according to one or more communication protocols. The TRX may provide the apparatus with communication capabilities to access the radio access network and enable communication between network nodes, for example. The TRX may comprise standard well-known components such as an amplifier, filter, frequency-converter, (de)modulator, and encoder/decoder circuitries and one or more antennas.

The apparatus 800 may also comprise user interface 840 comprising, for example, at least one keypad, a microphone, a touch display, a display, a speaker, etc. Each user interface may be used to control the respective apparatus by the user.

In an embodiment, the apparatus 800 is or is comprised in the at least one terminal device 110.

The control circuitry 810 may comprise traffic prediction requestor circuitry 812 configured to request network traffic prediction information from a network node, such as the network node 102. The control circuitry 810 may comprise coverage information requestor circuitry 814 configured to request coverage information of the network. The request may be sent the said network node or a group of network nodes. The control circuitry 810 may comprise service availability detector circuitry 816 configured to detect, based on the said network prediction information and the said coverage information, that a service availability will deteriorate. The control circuitry may further comprise quality of service requestor circuitry 818 configured to send a request, as a response to the said detection by the service availability detector circuitry 816, to a network node, wherein the request causes the network node to perform at least one of the following: predictively storing data in the at least one terminal device 110, changing the priority of the data transmission to the at least one terminal device 110, routing the data to the at least one terminal device 110 via a second network node, and delaying the data transmission to the at least one terminal device 110.

In an embodiment, as shown in FIG. 9, at least some of the functionalities of the apparatus 700 may be shared between two physically separate devices, forming one operational entity. Therefore, the apparatus 700 may be seen to depict the operational entity comprising one or more physically separate devices for executing at least some of the described processes. Thus, the apparatus 700 of FIG. 9, utilizing such shared architecture, may comprise a remote control unit (RCU) 952, such as a host computer or a server computer, operatively coupled (e.g. via a wireless or wired network) to a remote radio head (RRH) 954 located in the base station. In an embodiment, at least some of the described processes may be performed by the RCU 952. In an embodiment, the execution of at least some of the described processes may be shared among the RRH 954 and the RCU 952.

In an embodiment, the RCU 952 may generate a virtual network through which the RCU 952 communicates with the RRH 954. In general, virtual networking may involve a process of combining hardware and software network resources and network functionality into a single, software-based administrative entity, a virtual network. Network virtualization may involve platform virtualization, often combined with resource virtualization. Network virtualization may be categorized as external virtual networking which combines many networks, or parts of networks, into the server computer or the host computer (i.e. to the RCU). External network virtualization is targeted to optimized network sharing. Another category is internal virtual networking which provides network-like functionality to the software containers on a single system. Virtual networking may also be used for testing the terminal device.

In an embodiment, the virtual network may provide flexible distribution of operations between the RRH and the RCU. In practice, any digital signal processing task may be performed in either the RRH or the RCU and the boundary where the responsibility is shifted between the RRH and the RCU may be selected according to implementation.

As used in this application, the term ‘circuitry’ refers to all of the following: (a) hardware-only circuit implementations, such as implementations in only analog and/or digital circuitry, and (b) combinations of circuits and soft-ware (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

In an embodiment, at least some of the processes described in connection with FIGS. 1 to 6 may be carried out by an apparatus comprising corresponding means for carrying out at least some of the described processes. Some example means for carrying out the processes may include at least one of the following: detector, processor (including dual-core and multiple-core processors), digital signal processor, controller, receiver, transmitter, encoder, decoder, memory, RAM, ROM, software, firmware, display, user interface, display circuitry, user interface circuitry, user interface software, display software, circuit, antenna, antenna circuitry, and circuitry. In an embodiment, the at least one processor, the memory, and the computer program code form processing means or comprises one or more computer program code portions for carrying out one or more operations according to any one of the embodiments of FIGS. 1 to 6 or operations thereof. In an embodiment, these operations may comprise tasks, such as, obtaining, by a network node, network traffic prediction information, obtaining coverage information of the network, predicting a service availability for at least one terminal device based at least on the network traffic prediction information and the coverage information, and controlling, based on the service availability, a quality of service for the at least one terminal device. In an embodiment, these operations may comprise tasks, such as, requesting, by at least one terminal device, network traffic prediction information, requesting coverage information of the network, detecting, based on the network prediction information and the coverage information, that a service availability will deteriorate, and as a response to the said detection, sending a request to a network node, wherein the request causes the network node to perform at least one of the following: predictively storing data in the at least one terminal device, changing the priority of the data transmission to the at least one terminal device, routing the data to the at least one terminal device via a second network node, and delaying the data transmission to the at least one terminal device.

According to yet another embodiment, the apparatus carrying out the embodiments comprises a circuitry including at least one processor and at least one memory including computer program code. When activated, the circuitry causes the apparatus to perform at least some of the functionalities according to any one of the embodiments of FIGS. 1 to 6, or operations thereof. In an embodiment, these operations may comprise tasks, such as, obtaining, by a network node, network traffic prediction information, obtaining coverage information of the network, predicting a service availability for at least one terminal device based at least on the network traffic prediction information and the coverage information, and controlling, based on the service availability, a quality of service for the at least one terminal device. In an embodiment, these operations may comprise tasks, such as, requesting, by at least one terminal device, network traffic prediction information, requesting coverage information of the network, detecting, based on the network prediction information and the coverage information, that a service availability will deteriorate, and as a response to the said detection, sending a request to a network node, wherein the request causes the network node to perform at least one of the following: predictively storing data in the at least one terminal device, changing the priority of the data transmission to the at least one terminal device, routing the data to the at least one terminal device via a second network node, and delaying the data transmission to the at least one terminal device.

The techniques and methods described herein may be implemented by various means. For example, these techniques may be implemented in hardware (one or more devices), firmware (one or more devices), software (one or more modules), or combinations thereof. For a hardware implementation, the apparatus(es) of embodiments may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. For firmware or software, the implementation can be carried out through modules of at least one chip set (e.g. procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

Embodiments as described may also be carried out in the form of a computer process defined by a computer program or portions thereof. Embodiments of the methods described in connection with FIGS. 1 to 6 may be carried out by executing at least one portion of a computer program comprising corresponding instructions. The computer program may be in source code form, object code form, or in some intermediate form, and it may be stored in some sort of carrier, which may be any entity or device capable of carrying the program. For example, the computer program may be stored on a computer program distribution medium readable by a computer or a processor. The computer program medium may be, for example but not limited to, a record medium, computer memory, read-only memory, electrical carrier signal, telecommunications signal, and software distribution package, for example. The computer program medium may be a non-transitory medium. Coding of software for carrying out the embodiments as shown and described is well within the scope of a person of ordinary skill in the art.

Even though the invention has been described above with reference to an example according to the accompanying drawings, it is clear that the invention is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1. A method comprising:
obtaining, by a network node, network traffic prediction information of a network;
obtaining coverage information of the network;
predicting a service availability for at least one terminal device based at least on the network traffic prediction information and the coverage information; and
controlling, based on the service availability, a quality of service for the at least one terminal device.

2. The method of claim 1, wherein the controlling of the quality of service comprises at least one of the following:
predictively storing, by the network node, data in the at least one terminal device;
changing the priority of the data transmission to the at least one terminal device;
routing the data to the at least one terminal device via a second network node; and
delaying the data transmission to the at least one terminal device.

3. The method of claim 1 wherein the network traffic prediction information comprises at least one of the following:
information of available network resources;
estimation of future service requests in the network;
mobility information of the at least one terminal device; and
device characteristics of the at least one terminal device.

4. The method of claim 3, wherein the mobility information comprises at least one of the following:
location information of the at least one terminal device; and
trajectory information of the at least one terminal device.

5. The method of claim 1, further comprising:
performing, by the network node, a triggering, wherein the triggering causes the at least one terminal device to start transmitting mobility information.

6. The method of claim 5, wherein the triggering is performed when at least one of the following requirements is met:
detecting, by the network node, that a delay-tolerant application is running in the at least one terminal device;
detecting that the velocity of the at least one terminal device is above a predefined threshold; and
detecting that the at least one terminal device is under coverage of a heterogeneous network.

7. The method of claim 5, wherein performing the triggering comprises sending a request to the at least one terminal device, wherein the request causes the at least one terminal device to start transmitting the mobility information.

8. A method comprising:
requesting, by at least one terminal device, network traffic prediction information of a network;
requesting coverage information of the network;
detecting, based on the network traffic prediction information and the coverage information, that a service availability will deteriorate; and
sending, in response to the detecting, a request to a network node, wherein the request causes the network node to perform at least one of the following:
predictively storing data in the at least one terminal device;
changing the priority of the data transmission to the at least one terminal device;
routing the data to the at least one terminal device via a second network node; and
delaying the data transmission to the at least one terminal device.

9. The method of claim 8, wherein the network traffic prediction information comprises at least one of the following:
information of available network resources;
estimation of future service requests in the network;
mobility information of the at least one terminal device; and
device characteristics of the at least one terminal device.

10. The method of claim 9, wherein the mobility information comprises at least one of the following:
location information of the at least one terminal device; and
trajectory information of the at least one terminal device.

11. An apparatus comprising:
at least one processor and at least one memory including a computer program code, wherein the at least one memory and the computer program code are configured, with the at least one processor, to cause a network node to perform operations comprising:
obtaining network traffic prediction information of a network;
obtaining coverage information of the network;
predicting a service availability for at least one terminal device based at least on the network traffic prediction information and the coverage information; and
controlling, based on the service availability, a quality of service for the at least one terminal device.

12.-17. (canceled)

18. An apparatus, comprising:
at least one processor and at least one memory including a computer program code, wherein the at least one memory and the computer program code are configured, with the at least one processor, to cause at least one terminal device to perform operations comprising:
requesting network traffic prediction information of a network;
requesting coverage information of the network;
detecting, based on the network prediction information and the coverage information, that a service availability will deteriorate; and
sending, in response to the detecting, a request to a network node, wherein the request causes the network node to perform at least one of the following:
predictively storing data in the at least one terminal device;
changing the priority of the data transmission to the at least one terminal device;
routing the data to the at least one terminal device via a second network node; and
delaying the data transmission to the at least one terminal device.

19.-23. (canceled)
